(19) United States
(12) Patent Application Publication
(10) Pub. No.: US 2021/0012777 A1
(43) Pub. Date: Jan. 14, 2021

(54) CONTEXT ACQUIRING METHOD AND DEVICE BASED ON VOICE INTERACTION

(71) Applicant: Beijing Baidu Netcom Science Technology Co., Ltd., Beijing (CN)

(72) Inventors: Yang LIANG, Beijing (CN); Kun LIU, Beijing (CN); Shuangshuang QIAO, Beijing (CN); Xiangyue LIN, Beijing (CN); Chao HAN, Beijing (CN); Mingfa ZHU, Beijing (CN); Jiangliang GUO, Beijing (CN); Xu LI, Beijing (CN); Jun LIU, Beijing (CN); Shuo LI, Beijing (CN); Shiming YIN, Beijing (CN)

(73) Assignee: Beijing Baidu Netcom Science Technology Co., Ltd., Beijing (CN)

(21) Appl. No.: 16/936,967

(22) Filed: Jul. 23, 2020

Related U.S. Application Data
(63) Continuation of application No. PCT/CN2019/087203, filed on May 16, 2019.

(30) Foreign Application Priority Data
Jul. 2, 2018 (CN) 201810709792.8

(51) Int. Cl. G10L 15/25; G10L 25/57; G06K 9/00

(52) U.S. Cl. CPC G10L 15/25; G06K 9/00288; G10L 25/57

(57) ABSTRACT

Embodiments of the present disclosure provide a context acquiring method based on voice interaction and a device, the method comprising: acquiring a scene image collected by an image collection device at a voice start point of a current conversation, and extracting a face feature of each user in the scene image; if it is determined that there is a second face feature matching a first face feature according to the face feature of each user and a face database, acquiring a first user identifier corresponding to the second face feature from the face database; if it is determined that a stored conversation corresponding to the first user identifier is stored in a voice database, determine a context of a voice interaction according to the current conversation and the stored conversation, and after the voice end point of the current conversation is obtained, storing the current conversation into the voice database.

### CROSS-REFERENCE TO RELATED APPLICATION

This application is a continuation of International Application No. PCT/CN2019/087203, filed on May 16, 2019, which claims priority to Chinese Patent Application No. 201810709792.8, titled “CONTEXT ACQUIRING METHOD AND DEVICE BASED ON VOICE INTERACTION”, filed on Jul. 2, 2018, by BAIDU ONLINE NETWORK TECHNOLOGY (BEIJING) CO., LTD., both of which are hereby incorporated by reference in their entireties.

### TECHNICAL FIELD

Embodiments of the present disclosure relates to the field of voice interaction technology, and in particular to a context acquiring method based on voice interaction and a device.

### BACKGROUND

With development of artificial intelligence technology, research and use of intelligent voice interactive products have attracted much attention. The intelligent voice interaction is an interaction mode based on voice input, and a user can input his own request by voice, and the product can respond with corresponding content according to intention of the request.

In the prior art, in an application scene of an intelligent service robot, such as a welcome robot, a police robot, etc., there are often scenes in which a plurality of people simultaneously interact with the intelligent service robot. When a plurality of people talk to the robot, if the source of content of a conversation cannot be identified, context of the conversation cannot be accurately acquired, and accurate service cannot be provided to the user, resulting in a bad conversation experience. At present, a user is identified by natural language understanding based on meaning of the conversation under the assumption that there is no content of different topics in the conversation content of a same user and that the themes of the conversation content of two users do not overlap, so as to acquire the conversation context of the same user.

However, the assumption based on natural language understanding in practical applications is not always true, resulting in a higher error rate in acquiring a voice conversation context.

### SUMMARY

Embodiments of the present disclosure provides a context acquiring method based on voice interaction and a device, so as to overcome a problem of high error rate in acquiring a voice conversation context.

In a first aspect, an embodiment of the present disclosure provides a context acquiring method based on voice interaction, including:

acquiring a scene image collected by an image collection device at a voice start point of a current conversation, and extracting a face feature of each user in the scene image;

if it is determined that there is a second face feature matching a first face feature according to the face feature of each user and a face database, acquiring a first user identifier corresponding to the second face feature from the face database, wherein the first face feature is a face feature of a user, and the second face feature is a face feature of a user in conversation state stored in the face database; and

if it is determined that a stored conversation corresponding to the first user identifier is stored in a voice database, determining a context of a voice interaction according to the current conversation and the stored conversation, and after a voice end point of the current conversation is obtained, storing the current conversation into the voice database.

In a possible design, if it is determined that there is no second face feature matching the first face feature according to the face feature of each user and the face database, the method further includes:

analyzing parameters including the face feature of each user, acquiring a target user in the conversation state, and generating a second user identifier of the target user; and

when the voice end point is detected, storing the current conversation and the second user identifier into the voice database associatedly, and storing the face feature of the target user and the second user identifier into the face database associatedly.

By storing the current conversation and the second user identifier into the voice database associatedly, and storing the face feature of the target user and the second user identifier into the face database associatedly, a context can be acquired in the stored conversation based on the content in the face database and the voice database when the user performs voice interaction with the terminal again. The face database and the voice database are set separately to facilitate separate storage and maintenance of the face database and the voice database.

In a possible design, determining a context of a voice interaction according to the current conversation and the stored conversation, includes:

acquiring a voice start point and a voice end point of a last conversation corresponding to the first user identifier from the voice database according to the first user identifier; and

if it is determined that a time interval between the voice end point of the last conversation and the voice start point of the current conversation is less than a preset interval, determining the context of the voice interaction according to the current conversation and the stored conversation.

If the time interval is less than the preset interval, it means that the last conversation and the current conversation are more likely to be a context conversation, and if the time interval is greater than or equal to the preset interval, it indicates that the conversation is a previous conversation of the user for a topic, and cannot be regarded as a current context conversation. By determining whether the time interval between the voice end point of the last conversation and the voice start point of the current conversation is less than the preset interval, the context of the current conversation can be more accurately determined, and the accuracy of context acquiring is improved.

In a possible design, if it is determined that the time interval between the voice end point of the last conversation and the voice start point of the current conversation is greater than or equal to the preset interval, the method further includes:

deleting the first user identifier and a corresponding stored conversation stored associated from the voice database.

If the time interval is greater than or equal to the preset interval, it indicates that the conversation is the last conversation of the user for a topic, and cannot be regarded as the current context conversation. Thereby, the first user identifier and the corresponding stored conversation stored associatedly are deleted from the voice database, so that the data in the voice database can be kept as new data.

In a possible design, the method further includes:

deleting a third user identifier which is not matched within a preset time period and a corresponding face feature from the face database.

By using the deletion method, associatedly stored the user identifier and the face feature may be deleted in batches, thereby improving deletion efficiency, enabling data in the face database to be kept new, avoiding redundancy of the face database.

In a possible design, extracting the face feature of each user in the scene image, includes:

performing a matting process on the scene image to obtain a face image of each face; and

inputting a plurality of face images into a preset face feature model sequentially, and acquiring the face feature of each user sequentially output by the face feature model.

Acquiring the user's face feature by the face feature model, has not only a faster processing speed, but also high accuracy.

In a possible design, before inputting the plurality of face images into the preset face feature model, the method further includes:

acquiring a face training sample, the face training sample including a face image and a label;

acquiring, according to the face training sample, an initial face feature model after training; the initial face feature model including an input layer, a feature layer, a classification layer, and an output layer; and

deleting the classification layer in the initial face feature model to obtain the preset face feature model.

Through the above model training process, the initial face feature model is obtained, and the classification layer in the initial face feature model is deleted to acquire the preset face feature model. Since the classification layer is deleted, when the preset face feature model is used, when the face image is acquired from the scene image and input into the face feature model, the face feature model can output the face feature directly instead of outputting a classification result.

In a possible design, the face feature model is a deep convolutional neural network model, the feature layer including a convolution layer, a pooling layer, and a fully connected layer.

Using such a deep neural network model with convolution and pooling operations, it is highly robust to image deformation, blur, noise, etc., and has higher generalization for classification tasks.

In a second aspect, an embodiment of the present disclosure provides a context acquiring device based on voice interaction, including:

an extracting module, configured to acquire a scene image collected by an image collection device at a voice start point of a current conversation, and extract a face feature of each user in the scene image;

a matching module, configured to if it is determined that there is a second face feature matching a first face feature according to the face feature of each user and the face database, acquire a first user identifier corresponding to the second face feature from the face database, where the first face feature is a face feature of a user, and the second face feature is a face feature of a user in conversation state stored in the face database; and

an acquiring module, configured to, if it is determined that a stored conversation corresponding to the first user identifier is stored in the voice database, determine a context of a voice interaction according to the current conversation and the stored conversation, and after a voice end point of the current conversation is obtained, store the current conversation into the voice database.

In a possible design, the matching module is further configured to,

if it is determined that there is no second face feature matching the first face feature according to the face feature of each user and a face database, analyze parameters comprising the face feature of each user, acquire a target user in conversation state, and generate a second user identifier of the target user; and

when the voice end point is detected, store the current conversation and the second user identifier into the voice database associatedly, and store the face feature of the target user and the second user identifier into the face database associatedly.

In a possible design, the acquiring module is specifically configured to:

acquire a voice start point and a voice end point of a last conversation corresponding to the first user identifier from the voice database according to the first user identifier; and

if it is determined that a time interval between the voice end point of the last conversation and the voice start point of the current conversation is less than a preset interval, determine the context of the voice interaction according to the current conversation and the stored conversation.

In a possible design, the acquiring module is further configured to:

if it is determined that the time interval between the voice end point of the last conversation and the voice start point of the current conversation is greater than or equal to the preset interval, delete the first user identifier and a corresponding stored conversation stored associatedly from the voice database.

In a possible design, the matching module is further configured to:

delete a third user identifier which is not matched within a preset time period and a corresponding face feature from the face database.

In a possible design, the extracting module is specifically configured to:

perform a matting process on the scene image to obtain a face image of each face; and

input a plurality of face images into a preset face feature model sequentially, and acquire the face feature of each user sequentially output by the face feature model.

In a possible design, further including: a modeling module;

the modeling module is configured to, before sequentially input the plurality of face images into the preset face feature model,

acquire a face training sample, the face training sample including a face image and a label;

acquire, according to the face training sample, an initial face feature model after training; the initial face feature model including an input layer, a feature layer, a classification layer, and an output layer; and

delete the classification layer in the initial face feature model to obtain the preset face feature model.

In a possible design, the face feature model is a deep convolutional neural network model, and the feature layer includes a convolution layer, a pooling layer, and a fully connected layer.

In a third aspect, an embodiment of the present disclosure provides a context acquiring device based on voice interaction, includes: at least one processor and a memory;

the memory stores computer-executable instructions;

the at least one processor executes the computer-executable instructions stored in the memory, to cause the at least one processor to perform the context acquiring method based on voice interaction as described in the first aspect or various possible designs of the first aspect.

In a fourth aspect, an embodiment of the present disclosure provides a computer readable storage medium, the computer readable storage medium stores computer-executable instructions, and when a processor executes the computer-executable instructions, the context acquiring method based on voice interaction as described in the first aspect or various possible designs of the first aspect is implemented.

The context acquiring method based on voice interaction and the device provided by the embodiments, acquire a scene image collected by an image collection device at a voice start point of a current conversation, and extract a face feature of each user in the scene image. If it is determined that there is a second face feature matching a first face feature according to the face feature of each user and a face database, a first user identifier corresponding to the second face feature is acquired from the face database, where the first face feature is a face feature of the user, and the second face feature is a face feature of the user in a conversation state stored in the face database, and accurate identification of the user is achieved through face recognition. If it is determined that a stored conversation corresponding to the first user identifier is stored in a voice database, the context of the voice interaction is determined according to the current conversation and the stored conversation, and after a voice end point of the current conversation is obtained, the current conversation is stored into the voice database. A stored conversation belonging to the same user as the current conversation can be acquired by the user identifier, and the context of the voice interaction is acquired based on the conversation of the same user, thereby avoiding use of the conversation of different users as the context, and improving the accuracy of the context.

### BRIEF DESCRIPTION OF THE DRAWINGS

In order to illustrate the embodiments of the present disclosure or the technical solutions in the prior art more clearly, a brief description of the drawings used in the embodiments or the prior art description will be briefly described below. Obviously, the drawings in following description are some embodiments of the present disclosure, and those skilled in the art can acquire other drawings according to the drawings without any inventive labor.

FIG. 1 is a system architecture diagram of a context acquiring method based on voice interaction according to an embodiment of the present disclosure;

FIG. 2 is a first flowchart of a context acquiring method based on voice interaction according to an embodiment of the present disclosure;

FIG. 3 is a second flowchart of a context acquiring method based on voice interaction according to an embodiment of the present disclosure;

FIG. 4 is a schematic structural diagram of a face feature model according to an embodiment of the present disclosure;

FIG. 5 is a schematic structural diagram of a context acquiring device based on voice interaction according to an embodiment of the present disclosure;

FIG. 6 is a schematic hardware structural diagram of a context acquiring device based on voice interaction according to an embodiment of the present disclosure.

### DETAILED DESCRIPTION OF THE EMBODIMENTS

In order to make the objectives, technical solutions, and advantages of the embodiments of the present disclosure more clear, the technical solutions in the embodiments of the present disclosure are clearly and completely described below in conjunction with the drawings in the embodiments of the present disclosure. Obviously, the described embodiments are a part of the embodiments of the disclosure, rather than all of the embodiments. All other embodiments acquired by those skilled in the art based on the embodiments of the present disclosure without creative efforts are within the scope of the present disclosure.

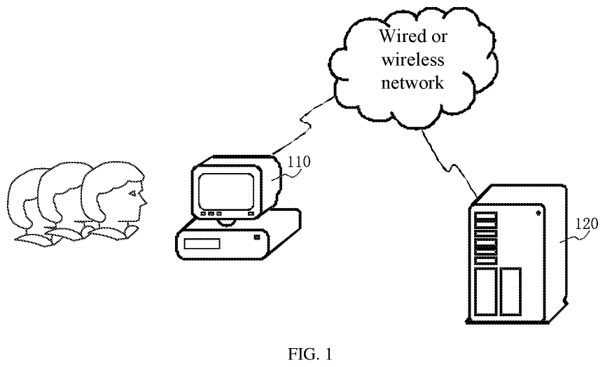

FIG. 1 is a system architecture diagram of a context acquiring method based on voice interaction according to an embodiment of the present disclosure. As shown in FIG. 1, the system includes a terminal 110 and a server 120. The terminal 110 can be a device with a voice interaction function, such as a story machine, a mobile phone, a tablet, a vehicle-mounted terminal, a welcome robot, a police robot, and the like.

The implementation manner of the terminal 110 in this embodiment is not particularly limited, as long as the terminal 110 can perform voice interaction with a user. In this embodiment, the terminal 110 further includes an image collection device. The image collection device can collect images of users who are in conversation with the terminal 110. The image collection device can be a camera, a video camera, etc. The server 120 can provide various online services, and can provide corresponding question and answer results for the user's questions.

The embodiment of the present disclosure is also applicable to a process in which a plurality of users have conversations with the terminal 110. The process in which a plurality of users have conversations with the terminal 110 involved in the embodiment may be: when a user A and the terminal 110 are in a conversation, a user B pipes up and talks to the terminal 110 in a gap of the conversation between the user A and the terminal 110. At this time, the user A and the user B interact with the terminal 110 alternately, thereby forming a multi-person conversation scene.

The embodiment of the disclosure identifies a user based on a voiceprint, and can acquire the context of the user, for example, can acquire the context of the user A and the context of the user B in a process where the user A and the user B interact with the terminal simultaneously, thereby reducing the error rate of context acquisition. After acquiring the context of a same user's voice interaction, combined with the context, a question and answer result is fed back to the user to improve the user experience.

The execution body of the embodiment of the present disclosure may be the server, where the terminal sends a conversation to the server after acquiring the conversation input by the user, and the server returns a question and answer result of the conversation. Those skilled in the art can understand that when the function of the terminal is sufficiently powerful, the terminal can also feedback the question and answer result by itself after acquiring the conversation. A context acquiring method based on voice interaction provided by the embodiments of the present disclosure is described in detail below by taking a server as an execution body.

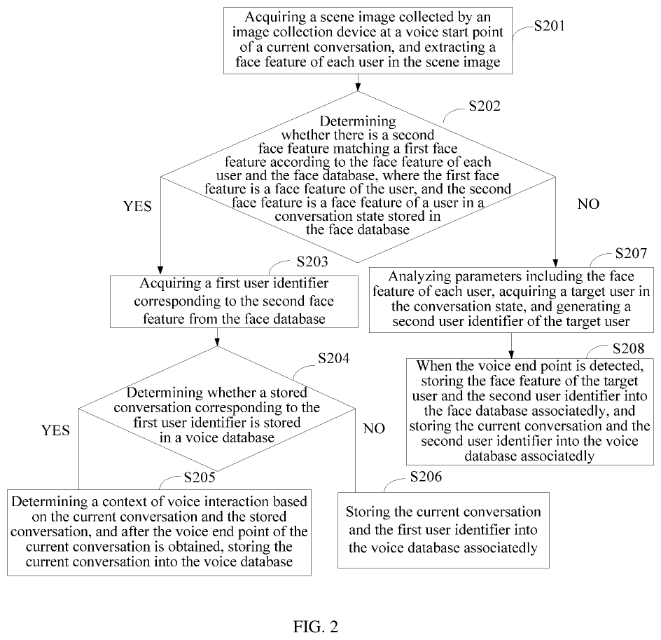

FIG. 2 is a first flowchart of a context acquiring method based on voice interaction according to an embodiment of the present disclosure, As shown in FIG. 2, the method includes:

S201, acquiring a scene image collected by an image collection device at a voice start point of a current conversation, and extracting a face feature of each user in the scene image.

With the development of human-computer interaction technology, voice recognition technology shows its importance. In voice recognition systems, voice endpoint detection technology is a very important technology, which is also commonly known as voice activity detection (VAD). Voice endpoint detection refers to find a voice start point and a voice end point of a voice part in a continuous sound signal. The specific implementation of the voice activity detection technology is not specifically limited in this embodiment. The execution entity of the voice activity detection technology may be the terminal mentioned above, or the terminal may send the voice to the server in real time and the server performs.

A current conversation and a stored conversation in this embodiment refer to a continuous voice input by the user to the terminal, i.e. a sentence. When describing “having a conversation”, the “conversation” can be understood as an action performed. The “conversation” of this embodiment can also be expressed as a noun in some scenes. For word class of the “conversation”, it can be determined according to the language description scene.

When the voice start point of the current conversation is detected, a scene image is acquired which is collected by the image collection device at the voice start point. That is, when a user performs a voice interaction with the terminal and speaks to the terminal, the scene image collected in the current scene is acquired. If there are a plurality of people facing the terminal, since there is a conversation, so in the image of the current scene, there is a user facing the terminal's microphone with the user's lip shape being a speaking lip shape, and at the same time, there may also be users with lateral or other orientations relative to the microphone of the terminal.

After acquiring the scene image, the face feature of each user is extracted from the scene image, for example, a face feature may be extracted by a face feature model.

In the extraction process, the face feature of the user is extracted per single user. Specifically, a matting process is performed on a scene image to acquire the face image of each face; a plurality of face images are input into the preset face feature model in turn, and the face feature of each user is sequentially outputted by the face feature model.

The face feature may be a multi-dimensional feature, for example, a multi-dimensional vector, with a vector of each dimension representing a feature, such as an eyebrow feature, an eye feature, a nose feature, etc., which will not be listed herein one by one in this embodiment.

In this embodiment, the terminal can also schedule the server according to a load of each server, that is, the steps of the embodiment are performed by a server with a light load.

S202, determining whether there is a second face feature matching a first face feature according to the face feature of each user and a face database, where the first face feature is a face feature of the user, and the second face feature is a face feature of a user in a conversation state stored in the face database; if yes, executing S203, if no, executing S207;

S203, acquiring a first user identifier corresponding to the second face feature from the face database.

After acquiring the face feature of each user, the face feature of each user is matched with the face feature in the face database to determine whether a user's first face feature can match the second face feature in the face database.

It can be understood by those skilled in the art that when a user faces the microphone in the forward direction, other users cannot face the microphone in the forward direction, so there is one user who is in the conversation state with the microphone in the collected scene image, therefore, it can be determined whether there is a user whose first face feature matches the second face feature. The matching in this embodiment can be understood as two face features with the highest similarity under the premise that the similarity of the face features is greater than a preset value, and the similarity can be a cosine similarity of the two face features.

When there is a face feature of a user capable of matching a second face feature in the conversation state (a state of opening mouth and speaking) in the face database, a first user identifier corresponding to the second face feature is acquired from the face database, then execute S204, S205 and S206 in sequence. The face feature in the conversation state and the corresponding user identifier are stored associatedly in the face database.

When there is no user's face feature that can match the second face feature in the conversation state (a state of opening mouth and speaking) in the face database, S207 and S208 are sequentially executed.

S204, determining whether a stored conversation corresponding to the first user identifier is stored in the voice database, and if yes, executing S205; if not, executing S206;

S205, determining a context of voice interaction based on the current conversation and the stored conversation, and after a voice end point of the current conversation is obtained, storing the current conversation into the voice database;

S206, storing the current conversation and the first user identifier into the voice database associatedly.

When there is a face feature of a user capable of matching the second face feature in the conversation state (the state of opening mouth and speaking) in the face database, it is determined whether there is a stored conversation corresponding to the first user identifier stored in the voice database. The user identifier and corresponding conversation are stored associatedly in the voice database.

If the stored conversation corresponding to the first user identifier is stored in the voice database, it indicates that the current conversation is not a first sentence input by the user to the terminal within a preset time period, then the context of voice interaction is determined based on the current conversation and the stored conversation, i.e., determining the context of the current conversation in the stored conversation. At this time, in a limited number of conversations, combined with natural language understanding, the stored conversation related to the current conversation can be acquired, that is, the context is acquired. After acquiring the voice end point of the current conversation, the current conversation is stored into the voice database, and an association between the current conversation and the first user identifier is established in the voice database.

If the stored conversation corresponding to the first user identifier is not stored in the voice database, the current conversation is the first sentence voice input by the user to the terminal within a preset time period, where the preset time period is a preset time period before the current time, for example, half an hour before the current time. At this time, it is considered that the current conversation does not have a context, and then the current conversation and the first user identifier are stored into the voice database associatedly.

In this embodiment, the voice database and the face database can also be combined into one database, that is, user identifier, corresponding face feature, and user conversation are stored associatedly in one database. In an embodiment, the face feature and corresponding user conversation can also be stored associatedly in the database directly.

At this time, if it is determined, according to the face feature of each user and the database, that there is a second face feature matching the first face feature, then the stored conversation corresponding to the second face feature is acquired from the database, the context of voice interaction is determined based on the current conversation and the stored conversation, and after the voice end point of the current conversation is obtained, the current conversation is stored into the voice database.

In this embodiment, the face database and the voice database are set separately to facilitate separate storage and maintenance of the face database and the voice database.

S207, analyzing parameters including the face feature of each user, acquiring a target user in the conversation state, and generating a second user identifier of the target user.

S208, when the voice end point is detected, storing the face feature of the target user and the second user identifier into the face database associatedly, and storing the current conversation and the second user identifier into the voice database associatedly.

When there is no user's face feature that can match the second face feature in the conversation state (the state of opening mouth and speaking) in the face database, it is indicated that the current user has never had a voice interaction with the terminal before, and at this time, the parameters including the face feature of each user are analyzed to acquire the target user in the conversation state, and the second user identifier of the target user is generated. The user identifier can be a number, a letter, etc. or a combination thereof. For another example, the user identifier of the target user may also be generated by using a hash algorithm. This embodiment does not specifically limit the implementation of the user identifier.

From this, when the voice end point is detected, the face feature of the target user and the second user identifier are stored into the face database associatedly, and the current conversation and the second user identifier are stored into the voice database associatedly, so that a context can be acquired in the stored conversation based on the content in the face database and the voice database when the user performs voice interaction with the terminal again.

The context acquiring method based on voice interaction provided by this embodiment, acquires a scene image collected by an image collection device at a voice start point of a current conversation, and extracts a face feature of each user in the scene image. If it is determined that there is a second face feature matching a first face feature according to the face feature of each user and a face database, the first user identifier corresponding to the second face feature is acquired from the face database, where the first face feature is a face feature of a user, and the second face feature is a face feature of a user in a conversation state stored in the face database, and accurate identification of users is achieved by face recognition. If it is determined that the stored conversation corresponding to the first user identifier is stored in the voice database, the context of the voice interaction is determined according to the current conversation and the stored conversation, and after the voice end point of the current conversation is obtained, the current conversation is stored into the voice database. The stored conversation belonging to the same user as the current conversation can be acquired by the user identifier, and the context of the voice interaction is obtained based on the conversation of the same user, thereby avoiding use of the conversation of different users as the context, and improving the accuracy of the context.

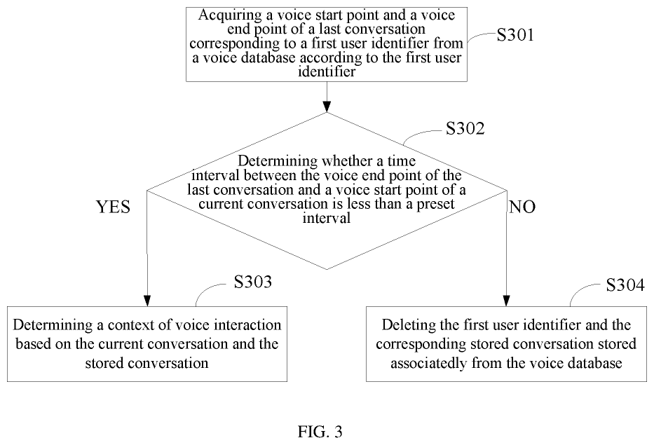

Following describes an implementation of determining context of voice interaction. FIG. 3 is a second flowchart of a context acquiring method based on voice interaction according to an embodiment of the present disclosure. As shown in FIG. 3, the method including:

S301, acquiring a voice start point and a voice end point of a last conversation corresponding to a first user identifier from a voice database according to the first user identifier;

S302, determining whether a time interval between the voice end point of the last conversation and a voice start point of a current conversation is less than a preset interval, if yes, executing S303, if not, executing S304;

S303, determining a context of voice interaction based on the current conversation and the stored conversation;

S304, deleting the first user identifier and the corresponding stored conversation stored associatedly from the voice database.

In a specific implementation process, the voice database stores a user identifier and each sentence corresponding to the user identifier, that is, the user identifier and at least one conversation of the user are stored associatedly. When each conversation is stored, the time of the voice start point and the time of the voice end point of the conversation are correspondingly stored.

After acquiring the first user identifier according to the face feature of the target user, the voice start point and the voice end point of the last conversation corresponding to the first user identifier are acquiring from the voice database according to the first user identifier.

Then the time interval between the voice end point of the last conversation and the voice start point of the current conversation is acquired according to the occurrence time of the voice end point of the last conversation and the occurrence time of the voice start point of the current conversation.

If the time interval is less than the preset interval, it means that the last conversation and the current conversation are more likely to be the context conversation, for example, the preset interval may be 10 minutes, 30 minutes, etc., and the implementation manner of the preset interval is not limited in this embodiment.

If the time interval is greater than or equal to the preset interval, it indicates that the conversation is a previous conversation of the user for a topic, and it is not regarded as a current context conversation. Thus, the first user identifier and corresponding stored conversation stored associatedly are deleted from the voice database, and there is no context for the current conversation.

In an embodiment, when deleting the first user identifier and corresponding stored conversation stored associatedly from the voice database, the first user identifier and corresponding face feature stored associatedly can also be deleted from the face database.

In an embodiment, both can also be deleted asynchronously, an third user identifier that is unmatched within a preset time period and a corresponding face feature can be deleted from the face database. By using the deletion method, the user identifier and the face feature stored associatedly may be deleted in batches, thereby improving the deletion efficiency.

A person skilled in the art can understand that each time a user's conversation is acquired, the above operations are performed, so that multiple conversations of each user stored in the voice database are conversations with a time interval smaller than the preset interval. Therefore, based on all of the stored conversations of the user and the current conversation, the context of the current conversation is obtained. For example, the current conversation and all the stored conversations of the user can be used as the context of the voice interaction, and for the conversation of the same user, the context of the current conversation can also be acquired from all the stored conversations based on natural language understanding.

In this embodiment, by determining whether the time interval between the voice end point of the last conversation and the voice start point of the current conversation is less than a preset interval, the context of the current conversation can be more accurately determined, and the accuracy of context acquiring is improved.

In the above embodiment, the embodiment of the present disclosure acquires the face feature of each user by using the face feature model. The process of constructing the face feature model is illustrated by the following detailed embodiment.

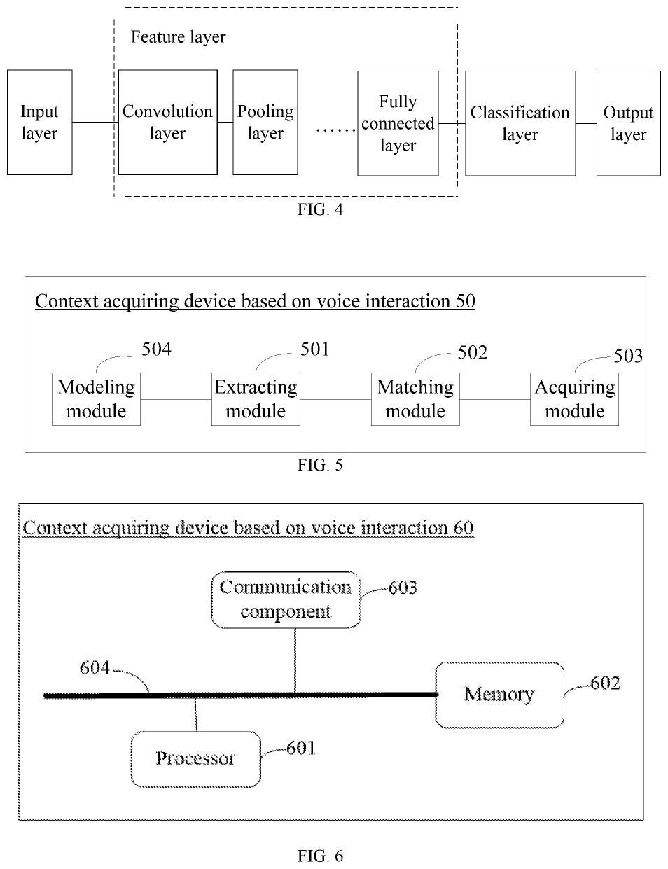

FIG. 4 is a schematic structural diagram of a face feature model according to an embodiment of the present disclosure. As shown in FIG. 4, the face feature model can use a Deep Convolutional Neural Network (Deep CNN). The model includes an input layer, a feature layer, a classification layer, and an output layer. In an embodiment, the feature layer includes a convolution layer, a pooling layer, and a fully connected layer. There may be a plurality of alternating convolution layers and pooling layers in the feature layer.

In a specific implementation process, for different usage scenes, based on the face feature model, a deep neural network model may be designed with different depths, different numbers of neurons, and different convolutional pooling modes.

When training the model, a face training sample is acquired, the face training sample including a face image and a label. The label is a pre-labelled classification result of each feature in the face image, and the label may be a vector in a matrix form.

The face image is input from the input layer, the input is actually a vector of matrixes, and then the convolution layer performs scanning convolution on the original image or feature map by using convolution kernels with different weights, to extract features of various meanings from the original image or feature map and output them to the feature map. The pooling layer is sandwiched between successive convolutional layers to compress the amount of data and parameters, reduce over-fitting, that is, reducing dimensionality of the feature map, and retain main features in the feature map. All neurons between the two layers have weighted connections, and generally, the fully connected layer is arranged at the end of the convolutional neural network. Finally, a result is output after the feature passing the classification layer.

Stop training when the error value between the output of the model and the label is less than a predetermined threshold that meets the business requirements. Using such a deep neural network model with convolution and pooling operations, it is highly robust to image deformation, blur, noise, etc., and has higher generalization for classification tasks.

Through the above model training process, an initial face feature model is obtained, and the classification layer in the initial face feature model is deleted to obtain the preset face feature model. Since the classification layer is deleted, when the preset face feature model is used, when the face image is acquired from the scene image by matting, the face image is input into the face feature model, the face feature model can output the face feature directly, instead of outputting the classification result.

This embodiment extracts the face feature by using a deep convolutional neural network model, to perform identity recognition, which can accurately distinguish the source of the conversation, find the conversation context of each person, and improve the conversation experience in a multi-person scene.

FIG. 5 is a schematic structural diagram of a context acquiring device based on voice interaction, according to an embodiment of the present disclosure. As shown in FIG. 5, the context acquiring device based on voice interaction 50 includes: an extracting module 501, a matching module 502, and an acquiring module 503. In an embodiment, a modeling module 504 is further included.

The extracting module 501 is configured to acquire a scene image collected by an image collection device at a voice start point of a current conversation, and extract a face feature of each user in the scene image.

The matching module 502 is configured to, if it is determined that there is a second face feature matching a first face feature according to the face feature of each user and a face database, acquire a first user identifier corresponding to the second face feature from the face database, where the first face feature is a face feature of a user and the second face feature is a face feature of a user in conversation state stored in the face database.

The acquiring module 503 is configured to, if it is determined that a stored conversation corresponding to the first user identifier is stored in a voice database, determine a context of a voice interaction according to the current conversation and the stored conversation, and after a voice end point of the current conversation is obtained, store the current conversation into the voice database.

In an embodiment, the matching module 502 is further configured to,

if it is determined that there is no second face feature matching the first face feature according to the face feature of each user and the face database, analyze parameters including the face feature of each user, acquire a target user in the conversation state, and generating a second user identifier of the target user; and

when the voice end point is detected, store the current conversation and the second user identifier into the voice database associatedly, and store the face feature of the target user and the second user identifier into the face database associatedly.

In an embodiment, the acquiring module 503 is specifically configured to:

acquire a voice start point and a voice end point of a last conversation corresponding to the first user identifier from the voice database according to the first user identifier; and

if it is determined that a time interval between the voice end point of the last conversation and the voice start point of the current conversation is less than a preset interval, determine the context of the voice interaction according to the current conversation and the stored conversation.

In an embodiment, the acquiring module 503 is further configured to:

if it is determined that the time interval between the voice end point of the last conversation and the voice start point of the current conversation is greater than or equal to the preset interval, delete the first user identifier and a corresponding stored conversation stored associatedly in the voice database.

In an embodiment, the matching module 502 is further configured to:

delete a third user identifier which is not matched within a preset time period and a corresponding face feature in the face database.

In an embodiment, the extracting module 501 is specifically configured to:

perform a matting process on the scene image to acquire a face image of each face; and

input a plurality of face images into a preset face feature model sequentially, and acquire the face feature of each user sequentially output by the face feature model.

The modeling module 504 is configured to, before sequentially input the plurality of face images into the preset face feature model, acquire a face training sample, the face training sample including a face image and a label;

according to the face training sample, obtain an initial face feature model after training; the initial face feature model including an input layer, a feature layer, a classification layer, and an output layer;

delete the classification layer in the initial face feature model to obtain the preset face feature model.

In an embodiment, the face feature model is a deep convolutional neural network model, and the feature layer includes a convolution layer, a pooling layer, and a fully connected layer.

The context acquiring device based on voice interaction provided in this embodiment is similar to the method embodiment in the foregoing, and the details is not described in this embodiment again.

FIG. 6 is a schematic hardware structural diagram of a context acquiring device based on voice interaction, according to an embodiment of the present disclosure. As shown in FIG. 6, the context acquiring device based on voice interaction 60 includes: at least one processor 601 and a memory 602. In an embodiment, the context acquiring device based on voice interaction 60 further includes a communication component 603. The processor 601, the memory 602, and the communication component 603 are connected by a bus 604.

In a specific implementation process, the at least one processor 601 executes computer-executable instructions stored by the memory 602, to cause the at least one processor 601 to perform the context acquiring method based on voice interaction as above.

The communication component 603 can perform data interaction with other devices.

For a specific implementation process of the processor 601, refer to the foregoing method embodiment, and the implementation principle and technical effects are similar, and the details are not described herein.

In the embodiment shown in the above FIG. 6, it should be understood that the processor may be a Central Processing Unit (CPU), or may be other general-purpose processor, Digital Signal Processor (DSP), Application Specific Integrated Circuit (ASIC) etc. The general-purpose processor may be a microprocessor or the processor may be any conventional processor, etc. The steps of the method disclosed in the embodiments of the present application may be directly implemented by hardware processor, or performed by a combination of hardware and software modules in the processor.

The memory may include a high-speed RAM memory, and may also include a non-volatile memory NVM, such as at least one disk memory.

The bus may be an Industry Standard Architecture (ISA) bus, a Peripheral Component (PCI) bus, or an Extended Industry Standard Architecture (ESA) bus. The bus can be divided into an address bus, a data bus, a control bus, etc. For convenience of representation, the bus in the drawing of the present application does not limit to only one bus or one type of bus.

The present application further provides a computer readable storage medium, the computer readable storage medium stores computer-executable instructions, and when a processor executes the computer-executable instructions, a context acquiring method based on voice interaction is implemented as described above.

The above computer readable storage medium, the readable storage medium may be implemented by any type of volatile or non-volatile storage device or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or an optical disc. The readable storage medium can be any available medium that can be accessed by a general purpose or special purpose computer.

An exemplary readable storage medium is coupled to the processor, such that the processor can read information from the readable storage medium and can write information to the readable storage medium. Of course, the readable storage medium may also be an integral part of the processor. The processor and the readable storage medium may be located in an Application Specific Integrated Circuits (ASIC). Of course, the processor and the readable storage medium may also exist as discrete components in the device.

The division of the unit is only a logical function division, and actual implementation may have another division manner. For example, multiple units or components can be combined or can be integrated into another system, or some features can be ignored, or not executed. In addition, the mutual coupling or direct coupling or communication connection shown or discussed may be an indirect coupling or communication connection through some interface, device or unit, and may be electrical, mechanical or otherwise.

The unit described as a separate component may or may not be physically separated, the component displayed as a unit may be or may not be a physical unit, that is, may be located in one place, or may be distributed to multiple network units. Part or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

The functions may be stored in a computer readable storage medium if implemented in the form of a software functional unit and sold or used as a standalone product. Based on such understanding, in the technical solution of the present disclosure, the essential part or the part that contributes to the prior art or the part of the technical solution can be embodied in a form of software product, the computer software product is stored in a storage medium and includes instructions for causing a computer device (which may be a personal computer, a server, or a network device, etc.) to perform all or part of the steps of the methods described in various embodiments of the present application. The foregoing storage medium includes: a U disk, a mobile hard disk, a Read-Only Memory (ROM), a Random Access Memory (RAM), a disk or an optical disk and other media that can store program codes.

A person of ordinary skill in the art may understand that all or part of steps of implementing the foregoing method embodiments may be completed by the program instructing relevant hardware. The aforementioned program can be stored in a computer readable storage medium. The program, when executed, performs the steps including the foregoing method embodiments; and the foregoing storage medium includes: various medium that can store program codes, such as a ROM, a RAM, a magnetic disk, or an optical disk.

Finally, it should be noted that the above embodiments are only used to explain the technical solutions of the present disclosure, but not to limit; although the present application has been described in detail with reference to the foregoing embodiments, those skilled in the art should understand that the technical solutions described in the foregoing embodiments may be modified, or some or all of the technical features may be equivalently replaced; however, these modifications or substitutions do not make the essence of corresponding technical solutions depart from of the scope of the embodiments of the present application.

What is claimed is:

1. A context acquiring method based on voice interaction, comprising:
acquiring a scene image collected by an image collection device at a voice start point of a current conversation, and extracting a face feature of each user in the scene image;
if it is determined that there is a second face feature matching a first face feature according to the face feature of each user and a face database, acquiring a first user identifier corresponding to the second face feature from the face database, wherein the first face feature is a face feature of a user, the second face feature is a face feature of a user in a conversation state stored in the face database; and
if it is determined that a stored conversation corresponding to the first user identifier is stored in a voice database, determining a context of a voice interaction according to the current conversation and the stored conversation, and after a voice end point of the current conversation is obtained, storing the current conversation into the voice database.

2. The method according to claim 1, wherein if it is determined that there is no second face feature matching the first face feature according to the face feature of each user and the face database, the method further comprises:
analyzing parameters comprising the face feature of each user, acquiring a target user in the conversation state, and generating a second user identifier of the target user; and
when the voice end point is detected, storing the current conversation and the second user identifier into the voice database associatedly, and storing the face feature of the target user and the second user identifier into the face database associatedly.

3. The method according to claim 1, wherein the determining a context of a voice interaction according to the current conversation and the stored conversation, comprises:
acquiring a voice start point and a voice end point of a last conversation corresponding to the first user identifier from the voice database according to the first user identifier; and
if it is determined that a time interval between the voice end point of the last conversation and the voice start point of the current conversation is less than a preset interval, determining the context of the voice interaction according to the current conversation and the stored conversation.

4. The method according to claim 3, wherein if it is determined that the time interval between the voice end point of the last conversation and the voice start point of the current conversation is greater than or equal to the preset interval, the method further comprises:
deleting the first user identifier and a corresponding stored conversation stored associatedly from the voice database.

5. The method according to claim 1, wherein the method further comprises:
deleting a third user identifier which is not matched within a preset time period and a corresponding face feature from the face database.

6. The method according to claim 1, wherein the extracting a face feature of each user in the scene image, comprises:
performing a matting process on the scene image to acquire a face image of each face; and
inputting a plurality of face images into a preset face feature model sequentially, to acquire the face feature of each user sequentially output by the face feature model.

7. The method according to claim 6, wherein before inputting the plurality of face images into the preset face feature model sequentially, the method further comprises:
acquiring a face training sample, the face training sample comprising a face image and a label;
acquiring, according to the face training sample, an initial face feature model after training; the initial face feature model comprising an input layer, a feature layer, a classification layer, and an output layer; and
deleting the classification layer in the initial face feature model to obtain the preset face feature model.

8. The method according to claim 7, wherein the face feature model is a deep convolutional neural network model, and the feature layer comprises a convolution layer, a pooling layer, and a fully connected layer.

9. A context acquiring device based on voice interaction, comprising: at least one processor and a memory; wherein
the memory stores computer-executable instructions; and
the at least one processor executes the computer-executable instructions stored in the memory to cause the at least one processor to:
acquire a scene image collected by an image collection device at a voice start point of a current conversation, and extract a face feature of each user in the scene image;
if it is determined that there is a second face feature matching a first face feature according to the face feature of each user and the face database, acquire a first user identifier corresponding to the second face feature from the face database, wherein the first face feature is a face feature of a user, and the second face feature is a face feature of a user in conversation state stored in the face database; and
if it is determined that a stored conversation corresponding to the first user identifier is stored in the voice database, determine a context of a voice interaction according to the current conversation and the stored conversation, and after a voice end point of the current conversation is obtained, store the current conversation into the voice database.

10. The device according to claim 9, wherein the at least one processor executes the computer-executable instructions stored in the memory to cause the at least one processor to:
if determining that there is no second face feature matching the first face feature according to the face feature of each user and a face database, analyze parameters comprising the face feature of each user, acquire a target user in conversation state, and generate a second user identifier of the target user; and
when the voice end point is detected, store the current conversation and the second user identifier into the voice database associatedly, and store the face feature of the target user and the second user identifier into the face database associatedly.

11. The device according to claim 9, wherein the at least one processor executes the computer-executable instructions stored in the memory to cause the at least one processor to:
acquire a voice start point and a voice end point of a last conversation corresponding to the first user identifier from the voice database according to the first user identifier; and
if it is determined that a time interval between the voice end point of the last conversation and the voice start point of the current conversation is less than a preset interval, determine the context of the voice interaction according to the current conversation and the stored conversation.

12. The device according to claim 11, wherein the at least one processor executes the computer-executable instructions stored in the memory to cause the at least one processor further to:
if it is determined that the time interval between the voice end point of the last conversation and the voice start point of the current conversation is greater than or equal to the preset interval, delete the first user identifier and corresponding stored conversation stored associatedly from the voice database.

13. The device according to claim 9, wherein the at least one processor executes the computer-executable instructions stored in the memory to cause the at least one processor further to:
delete a third user identifier which is not matched within a preset time period and a corresponding face feature from the face database.

14. The device according to claim 9, wherein the at least one processor executes the computer-executable instructions stored in the memory to cause the at least one processor to:
perform a matting process on the scene image to acquire a face image of each face; and
input a plurality of face images into a preset face feature model sequentially, and acquire the face feature of each user sequentially output by the face feature model.

15. The device according to claim 14, the at least one processor executes the computer-executable instructions stored in the memory to cause the at least one processor further to:
before sequentially input the plurality of face images into the preset face feature model,
acquire a face training sample, the face training sample comprising a face image and a label;
acquire, according to the face training sample, an initial face feature model after training; the initial face feature model comprising an input layer, a feature layer, a classification layer, and an output layer; and
delete the classification layer in the initial face feature model to obtain the preset face feature model.

16. The device according to claim 15, wherein the face feature model is a deep convolutional neural network model, and the feature layer comprises a convolution layer, a pooling layer and a fully connected layer.

17. A computer readable storage medium, wherein the computer readable storage medium stores computer-executable instructions, and when a processor executes the computer-executable instructions, the context acquiring method based on voice interaction according to claim 1 is implemented.
